(19) United States
(12) Patent Application Publication
(10) Pub. No.: US 2021/0316470 A1
(43) Pub. Date: Oct. 14, 2021

(54) ROLLER FOR PAPER CUTTING DEVICE AND ROTARY CUTTING MODULE WITH THE SAME

(71) Applicant: JIUNCHEN TECHNOLOGY CO., LTD., New Taipei City (TW)

(72) Inventor: SHI-CHEN FAN, NEW TAIPEI CITY (TW)

(21) Appl. No.: 16/844,069

(22) Filed: Apr. 9, 2020

(51) Int. Cl. B26D 7/26; B26D 1/38

(52) U.S. Cl. CPC B26D 7/2628; B26D 7/2614; B26D 1/385

(57) ABSTRACT

A rotary cutting module for a paper cutting device has a roller and a paper-cutting blade. The roller extends along a rotating axis. A blade mount and multiple dynamic balancing recess sets are formed on an outer circumferential surface of the roller. The dynamic balancing recess sets are disposed apart from each other along the rotating axis. Each one of the dynamic balancing recess sets has multiple balancing recesses annularly disposed apart from each other. A depth of one of the balancing recesses of one of the dynamic balancing recess sets is different from a depth of one of the balancing recesses of another one of the dynamic balancing recess sets. Center of mass of each axial segment of the rotary cutting module can be adjusted individually to mitigate couple unbalance, thereby mitigating dynamic unbalance.

### BACKGROUND OF THE INVENTION

### 1. Field of the Invention

The present invention relates to a paper cutting structure, especially to a roller for a paper cutting device and a rotary cutting module with the same.

### 2. Description of the Prior Arts

With reference to FIGS. 4 to 6, a conventional rotary paper cutting machine has two rotary cutting modules 90 disposed parallel to and apart from each other. Each one of the rotary cutting modules 90 has a roller 91 and a cutting blade 92. The cutting blade 92 is mounted on an outer circumferential surface of the roller 91. To cut paper, place an unprocessed paper sheet P between the two rotary cutting modules 90 (as shown in FIG. 5), and then rotate both of the rotary cutting modules 90 one full turn to cut the paper sheet P in half (as shown in FIG. 6).

To reduce wobbling of the rotary cutting modules 90 caused by dynamic unbalance (that is, center of mass being out of alignment with its rotating axis L) during the rotary cutting process, multiple elongated balancing planes 912 are formed on a surface of the roller 91, and the balancing planes 912 extend from one end of the roller 91 to the other end of the roller 91. A balancing plane 9121 located opposite to the cutting blade 92 is more distant from the rotating axis L, making a wall of the roller 91 corresponding to the balancing plane 9121 thicker (difference of wall thickness is nonobvious because figures are schematic and not drawn to scale), which compensates the weight from the cutting blade 92. The other balancing planes 912 can compensate deviation of mass center due to geometric dimension deviation, such as circularity error or concentricity error, of the roller 91. Said geometric dimension deviation of the roller 91 is inevitable due to manufacturing tolerances.

However, dynamic unbalance includes static unbalance and couple unbalance. The conventional balancing planes 912 mitigate only static unbalance of the rotary cutting modules 90. Couple unbalance of the rotary cutting modules 90 cannot be mitigated by the balancing planes 912.

Concerning static unbalance: static unbalance occurs when the center of mass of one of the rotary cutting modules 90 deviates from its rotating axis L. Forming a balancing plane 912 removes material from a side of the roller 91, and therefore is capable of moving the center of mass of said rotary cutting module 90 toward the rotating axis L to mitigate static unbalance of said rotary cutting module 90.

Concerning couple unbalance: couple unbalance occurs when two forces of the same magnitude but opposite directions act on a rotating object. For example, if two virtual balancing weights 93 are fixed on a perfectly balanced rotary cutting module 90, and the two balancing weights 93 are located radially opposite each other (as shown in FIG. 7), the center of mass of said rotary cutting module 90 remains in alignment with the rotating axis L. However, when said rotary cutting module 90 is in rotation, the two virtual balancing weights 93 generate forces that are opposite each other, and therefore said rotary cutting module 90 deforms and wobbles when in rotation. In other words, couple unbalance occurs when an inertia axis Lg and the rotating axis L of the rotary cutting module 90 are non-parallel (as shown in FIG. 7). Although the conventional balancing planes 912 are capable of changing the position of center of mass of the rotary cutting module 90, couple unbalance cannot be corrected by changing the position of center of mass of the rotary cutting module 90, and therefore the conventional balancing planes 912 cannot mitigate the deformation and wobbling caused by couple unbalance.

To be more precise, the rotary cutting module 90 can be seen as multiple ring-shaped circular units arranged along the rotating axis L and connected together. Even if center of mass of all circular units combined is in alignment with the rotating axis L, center of mass of each one of the circular units may deviate from the rotating axis L in different directions, and therefore results in couple unbalance. The balancing planes 912 can only move the center of masses of all the circular units toward one direction because each one of the balancing planes 912 extends through all of the circular units. The balancing planes 912 cannot align the center of mass of one circular unit without affecting the center of mass of the other circular units. Therefore, the conventional balancing planes 912 cannot mitigate the deformation and wobbling caused by couple unbalance. The deformation and wobbling affects dimensional accuracy of the paper cutting, creates ragged cutting edges, and reduces service lives of the cutting blades 92 and driving mechanism for the rotary cutting modules 90.

Therefore, the roller of the conventional paper cutting device and the rotary cutting module with the same needs to be improved.

To overcome the shortcomings, the present invention provides a roller for a paper cutting device and a rotary cutting module with the same to mitigate or obviate the aforementioned problems.

### SUMMARY OF THE INVENTION

The main objective of the present invention is to provide a roller for a paper cutting device and a rotary cutting module with the same, whose structures enable correction of couple unbalance, and thereby improving dynamic balancing.

The roller for a paper cutting device and a rotary cutting module with the same has a roller and a paper-cutting blade. The roller extends along a rotating axis, and has a blade mount and multiple dynamic balancing recess sets. The blade mount is formed on an outer circumferential surface of the roller. The dynamic balancing recess sets are formed on the outer circumferential surface of the roller. The dynamic balancing recess sets are disposed apart from each other along the rotating axis. Each one of the dynamic balancing recess sets has multiple balancing recesses. The balancing recesses are annularly disposed apart from each other. A depth of one of the balancing recesses of one of the dynamic balancing recess sets is different from a depth of one of the balancing recesses of another one of the dynamic balancing recess sets.

The advantage of the present invention is that the dynamic balancing recess sets are formed on the outer circumferential surface of the roller and along the rotating axis. The depth of one of the balancing recesses of one of the dynamic balancing recess sets is different from a depth of one of the balancing recesses of another one of the dynamic balancing recess sets. Center of mass of each axial segment of the rotary cutting module along the rotating axis can be adjusted individually by adjusting the depth of the balancing recesses located at different axial positions, thereby correcting the couple unbalance of the rotary cutting module. The dynamic unbalance of the rotary cutting module is therefore mitigated.

In other words, the rotary cutting module can be seen as multiple ring-shaped circular units arranged along the rotating axis and connected together. Center of mass of each one of the circular units deviates from the rotating axis L when the rotor is in a semi-finished condition, that is, before the dynamic balancing recess sets are formed, because thickness of the roller and thickness of the paper-cutting blade are not uniform due to manufacturing error. In the present invention, the dynamic balancing recess sets are formed respectively on each one of the circular units, and the depth of each one of the balancing recesses can be adjusted individually according to the dynamic balance status. Therefore, a position of the center of mass of each one of the circular units can be aligned with the rotating axis, which means static unbalance and couple unbalance can both be mitigated. Dimensional accuracy of the paper cutting, quality of cutting edges, and service lives of the cutting blade and driving mechanism for the rotary cutting modules can be improved.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a roller in accordance with the present invention;

FIG. 2 is a side view of the roller in FIG. 1;

FIG. 3 is a sectional view of a rotary cutting module in accordance with the present invention;

FIG. 4 is a perspective view of a conventional paper cutting device;

FIGS. 5 and 6 are profile section views of the paper cutting device in FIG. 4, shown in different statuses; and

FIG. 7 is a side view of a roller of the paper cutting device in FIG. 4.

### DETAILED DESCRIPTION OF THE PREFERRED EMBODIMENTS

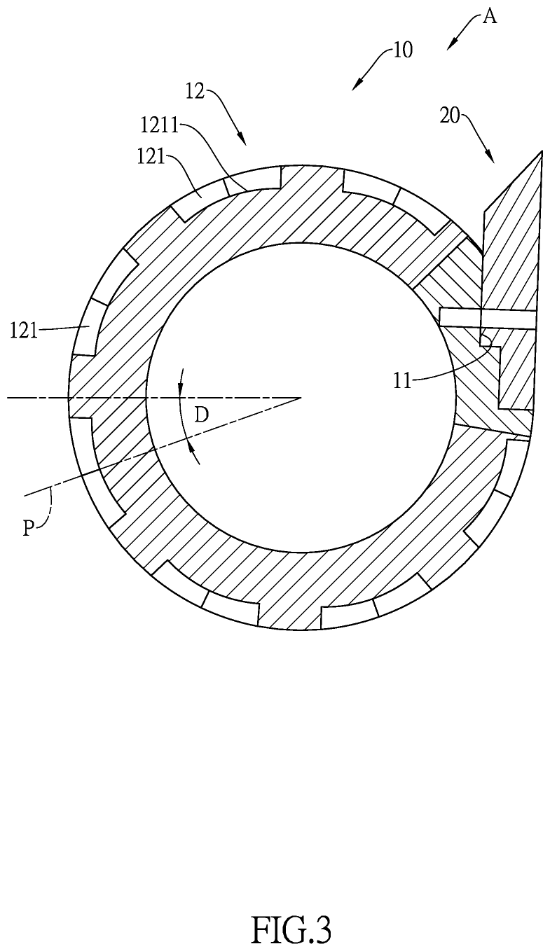

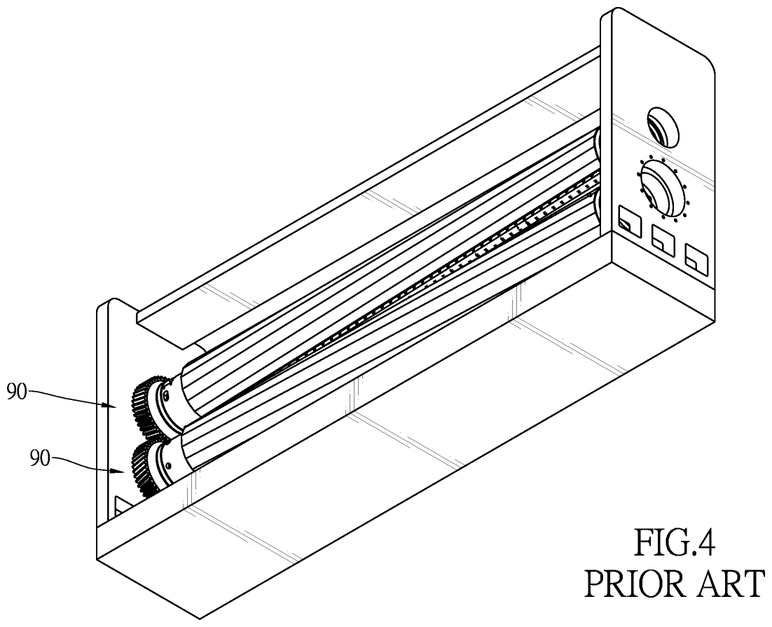

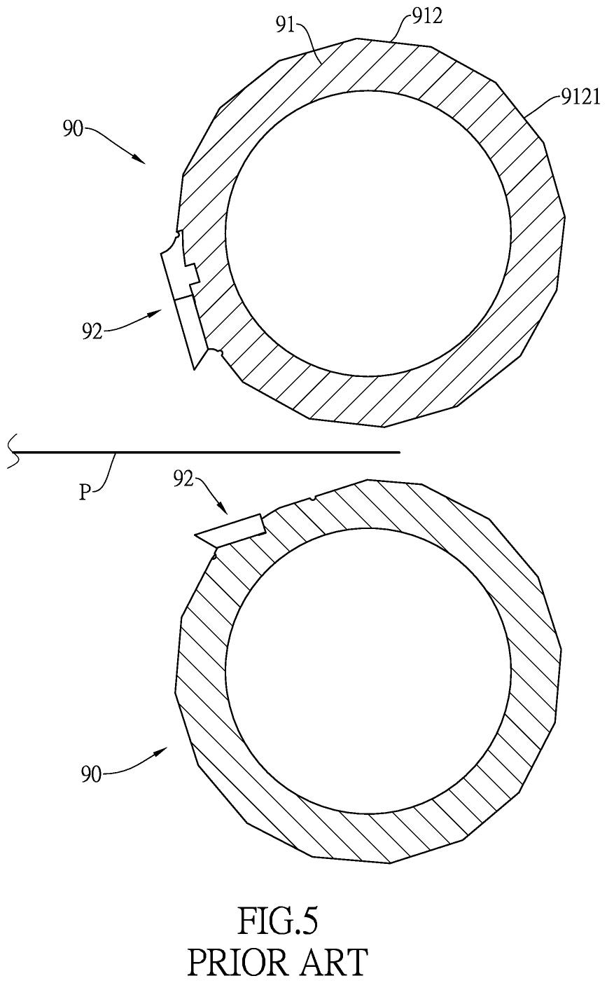

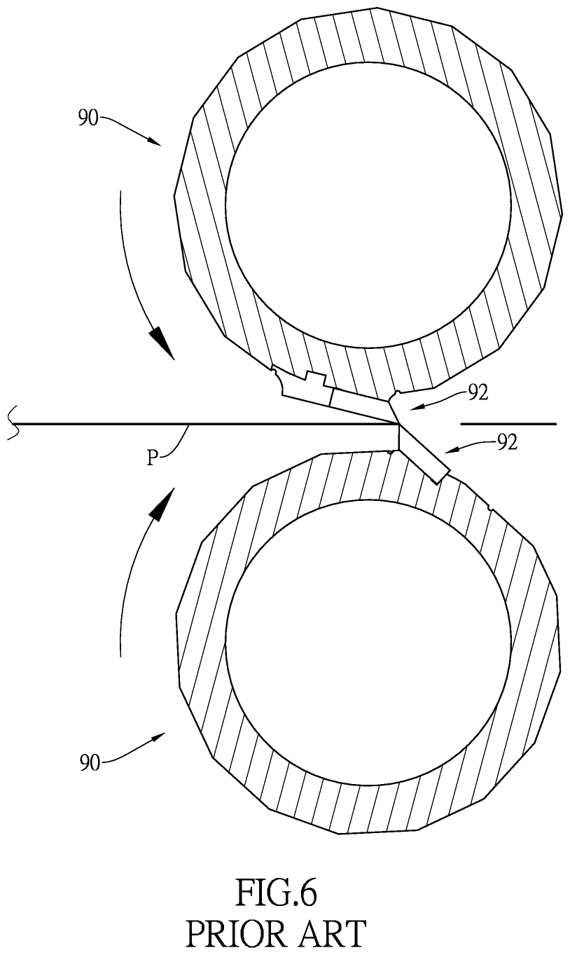

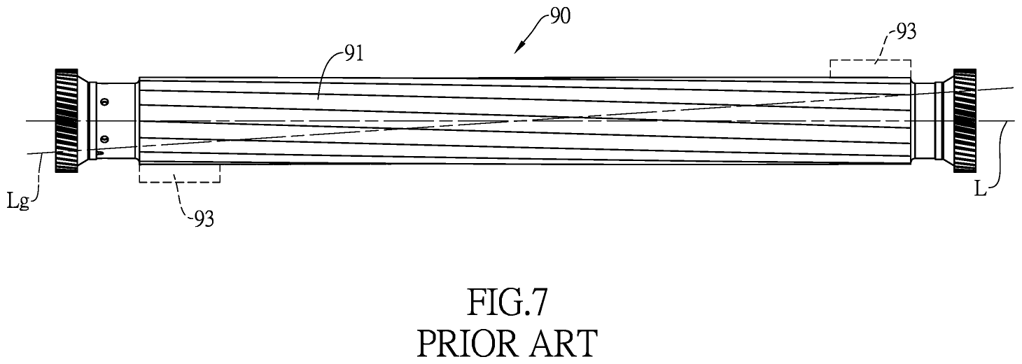

With reference to FIG. 3, a rotary cutting module A for a roller for a paper cutting device in accordance with the present invention comprises a roller 10 and a paper-cutting blade 20. The paper-cutting blade 20 is mounted on an outer circumferential surface of the roller 10.

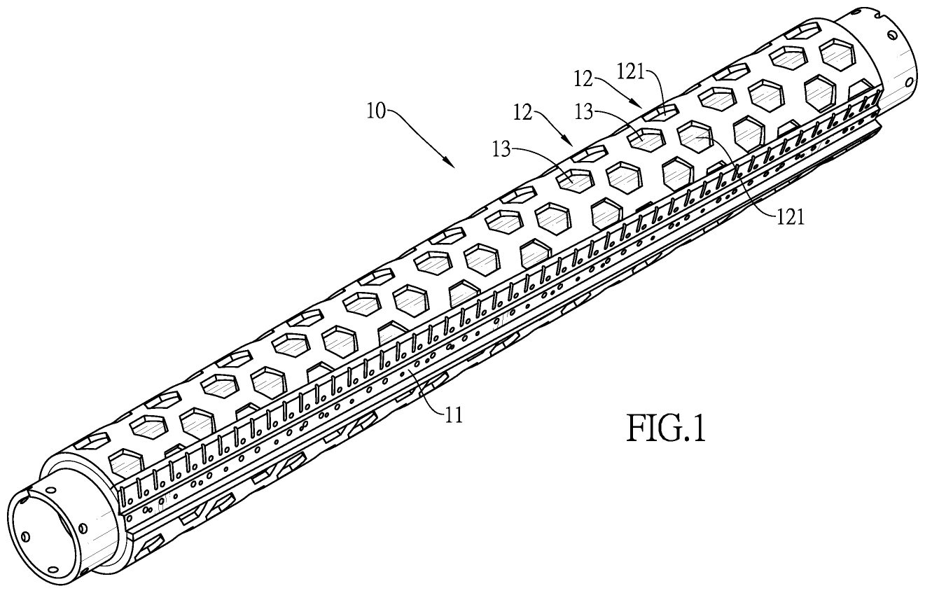

With reference to FIGS. 1 to 3, the roller 10 extends along a rotating axis L. A blade mount 11 and multiple dynamic balancing recess sets are formed on an outer circumferential surface of the roller 10. The paper-cutting blade 20 is fixed to the blade mount 11.

The dynamic balancing recess sets are disposed apart from each other along the rotating axis L. In a preferred embodiment, the dynamic balancing recess sets include multiple first dynamic balancing recess sets 12 and multiple second dynamic balancing recess sets 13. The first dynamic balancing recess sets 12 and the second dynamic balancing recess sets 13 are arranged in a staggered manner along the rotating axis L.

Each one of first the dynamic balancing recess sets 12 has multiple balancing recesses 121 annularly disposed apart from each other. Each one of the second dynamic balancing recess sets 13 has multiple balancing recesses 131 annularly disposed apart from each other. The balancing recesses 121 of each one of the first dynamic balancing recess sets 12 and the adjacent balancing recesses 131 of any one of the second dynamic balancing recess sets 13 are arranged in a staggered manner along a circumference of the roller 10. However, the arrangement of the balancing recesses 121 and adjacent balancing recesses 13 1 is not limited thereto. Furthermore, the dynamic balancing recess sets do not have to include staggeredly arranged first dynamic balancing recess sets 12 and second dynamic balancing recess sets 13, as long as the dynamic balancing recess sets are arranged along the rotating axis L and disposed apart from each other.

Among the balancing recess sets, a depth of one of the balancing recesses of one of the dynamic balancing recess sets is different from a depth of one of the balancing recesses of another one of the dynamic balancing recess sets, through which dynamic balance of the rotary cutting module A can be improved.

The efficacy of the dynamic balancing recess sets are as follows: the rotary cutting module A can be seen as multiple ring-shaped circular units arranged along the rotating axis L and connected together. Center of mass of each one of the circular units deviates from the rotating axis L when the rotor 10 is in a semi-finished condition, that is, before the dynamic balancing recess sets are formed, because thickness of the roller 10 and thickness of the paper-cutting blade 20 are not uniform due to manufacturing error. In the present invention, the dynamic balancing recess sets are formed respectively on each one of the circular units, and the depth of each one of the balancing recesses can be adjusted individually according to the dynamic balance status. Therefore, a position of the center of mass of each one of the circular units can be aligned with the rotating axis L, which means static unbalance and couple unbalance can both be mitigated.

In a preferred embodiment, a balance quality grade of each one of the circular units conforms to ISO 1940 balance quality grade of G6.3. A balance quality grade of the rotary cutting module A conforms to ISO 1940 balance quality grade of G6.3 because center of mass of each axial segment, that is, the circular unit, of the rotary cutting module A is in alignment with the rotating axis L, thereby mitigating both the static unbalance and the couple unbalance of the rotary cutting module A. The axial dimension of the roller 10 is more than 1.5 meters in a preferred embodiment.

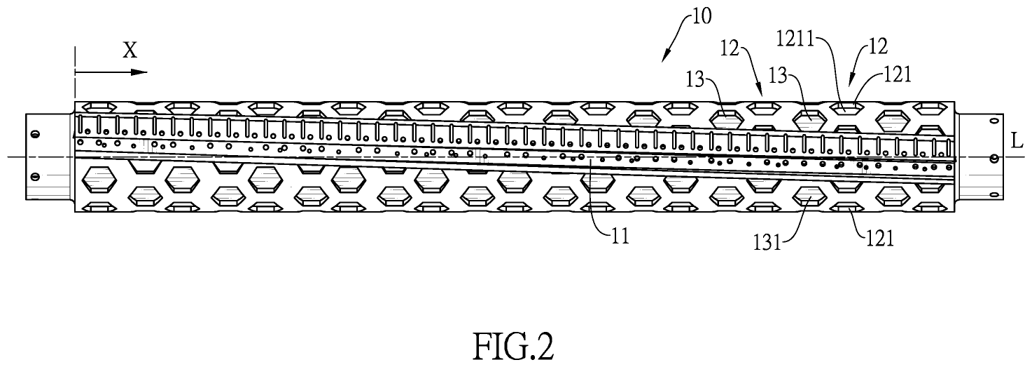

With reference to Table 1A and Table 1B, a preferred depth of all the balancing recesses are listed, wherein position X is defined as a distance between one of the balancing recesses 121, 131 and an end of the roller 10 (as shown in FIG. 2), and an angle D is defined as a relative angular position between a balancing recess 121, 131 and a reference plane P. According to Table 1A and Table 1B, the distance between one of the first dynamic balancing recess sets 12 and said end of the roller 10 is 55 millimeters, and the balancing recesses 121 are annularly disposed apart at 45 degrees. To be more precise, the balancing recesses 121 of the said first dynamic balancing recess set 12 are respectively located at angular positions of 0, 45, 90, 135, 180, 225, 270, and 315 degrees, and the depths of said balancing recesses 121 are respectively 6, 8, 9.3, 10, 6, 8, 9.3, and 10 millimeters. One of the second dynamic balancing recess sets 13 is at a position 160 millimeters away from said end of the roller. The balancing recesses 131 of the said second dynamic balancing recess set 13 are respectively located at angular positions of 22.5, 67.5, 112.5, 157.5, 202.5, 247.5, 292.5, and 337.5 degrees, and the depths of said balancing recesses 121 are respectively 6, 8, 9.3, 10, 6, 8, 9.3, and 10 millimeters. The depths of the balancing recess 121 and balancing recess 131 in the figures are schematic and not drawn to scale according to Table 1A and Table1B.

TABLE 1A
depth of the balancing recess 121, 131
(unit of the depth is in millimeter)

| | angle D | | | | | | | |
|---|---|---|---|---|---|---|---|---|
| position X | (Deg) | | | | | | | |
| (mm) | 0 | 22.5 | 45 | 67.5 | 90 | 112.5 | 135 | 157.5 |
| 55 | 6 | — | 8 | — | 9.3 | — | 10 | — |
| 160 | — | 6 | — | 8 | — | 9.3 | — | 10 |
| 245 | 6 | — | 8 | — | 9.3 | — | 10 | — |
| 350 | — | 6 | — | 8 | — | 9.3 | — | 10 |
| 435 | 6 | — | 8 | — | 9.3 | — | 10 | — |
| 540 | — | 6 | — | 8 | — | 9.3 | — | 10 |
| 625 | 6 | — | 8 | — | 9.3 | — | 10 | — |
| 730 | — | 6 | — | 8 | — | 9.3 | — | 10 |
| 815 | 6 | — | 8 | — | 9.3 | — | 10 | — |
| 920 | — | 6 | — | 8 | — | 9.3 | — | 10 |
| 1005 | 6 | — | 8 | — | 9.3 | — | 10 | — |
| 1110 | — | 6 | — | 8 | — | 9.3 | — | 10 |
| 1195 | 6 | — | 8 | — | 9.3 | — | 10 | — |
| 1300 | — | 6 | — | 8 | — | 9.3 | — | 10 |
| 1385 | 6 | — | 8 | — | 9.3 | — | 10 | — |
| 1490 | — | 6 | — | 8 | — | 9.3 | — | 10 |
| 1575 | 6 | — | 8 | — | 9.3 | — | 10 | — |
| 1680 | — | 6 | — | 8 | — | 9.3 | — | 10 |
| 1765 | 6 | — | 8 | — | 9.3 | — | 10 | — |
| 1870 | — | 6 | — | 8 | — | 9.3 | — | 10 |
| 1955 | 6 | — | 8 | — | 9.3 | — | 10 | — |

TABLE 1B
depth of the balancing recess 121, 131
(unit of the depth is in millimeter)

| | angle D | | | | | | | |
|---|---|---|---|---|---|---|---|---|
| position X | (Deg) | | | | | | | |
| (mm) | 180 | 202.5 | 225 | 247.5 | 270 | 292.5 | 315 | 337.5 |
| 55 | 9.3 | — | 10 | — | 9.3 | — | 8 | — |
| 160 | — | 9.3 | — | 10 | — | 9.3 | — | 8 |
| 245 | 9.3 | — | 10 | — | 9.3 | — | 8 | — |
| 350 | — | 9.3 | — | 10 | — | 9.3 | — | 8 |
| 435 | 9.3 | — | 10 | — | 9.3 | — | 8 | — |
| 540 | — | 9.3 | — | 10 | — | 9.3 | — | 8 |
| 625 | 9.3 | — | 10 | — | 9.3 | — | 8 | — |
| 730 | — | 9.3 | — | 10 | — | 9.3 | — | 8 |
| 815 | 9.3 | — | 10 | — | 9.3 | — | 8 | — |
| 920 | — | 9.3 | — | 10 | — | 9.3 | — | 8 |
| 1005 | 9.3 | — | 10 | — | 9.3 | — | 8 | — |
| 1110 | — | 9.3 | — | 10 | — | 9.3 | — | 8 |
| 1195 | 9.3 | — | 10 | — | 9.3 | — | 8 | — |
| 1300 | — | 9.3 | — | 10 | — | 9.3 | — | 8 |
| 1385 | 9.3 | — | 10 | — | 9.3 | — | 8 | — |
| 1490 | — | 9.3 | — | 10 | — | 9.3 | — | 8 |
| 1575 | 9.3 | — | 10 | — | 9.3 | — | 8 | — |
| 1680 | — | 9.3 | — | 10 | — | 9.3 | — | 8 |
| 1765 | 9.3 | — | 10 | — | 9.3 | — | 8 | — |
| 1870 | — | 9.3 | — | 10 | — | 9.3 | — | 8 |
| 1955 | 9.3 | — | 10 | — | 9.3 | — | 8 | — |

Additionally, the balancing recesses 121, 131 of the dynamic balancing recess sets 12, 13 are orderly arranged on the outer circumferential surface of the roller 10, and all of the balancing recesses 121, 131 are hexagonal recesses. The position and the shape of the balancing recesses 121, 131 reduce weight of the roller 10 without losing strength. Furthermore, a bottom 1211 of each one of the balancing recesses 121 is a curved surface protruding outward to reduce deformation of the roller 10 during high-speed rotating to maintain dynamic balance. Bottoms of the balancing recesses 131 share the same design as the bottoms 1211. When the roller 10 is strong enough to prevent excessive deformation, the bottoms of the balancing recess 121 and balancing recess 131 can be flat for ease of manufacturing.

To sum up, the static unbalance and the couple unbalance of the rotary cutting module A can be corrected by having the dynamic balancing recess sets formed on the outer circumferential surface of the roller 10 and along the rotating axis, and each of the dynamic balancing recess sets has balancing recesses annularly disposed apart from each other. The dynamic unbalance of the rotary cutting module A is thereby mitigated.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A rotary cutting module for a paper cutting device comprising:
a roller extending along a rotating axis; the roller having:
a blade mount formed on an outer circumferential surface of the roller; and
multiple dynamic balancing recess sets formed on the outer circumferential surface of the roller; the dynamic balancing recess sets disposed apart from each other along the rotating axis; each one of the dynamic balancing recess sets having
multiple balancing recesses annularly disposed apart from each other; a depth of one of the balancing recesses of one of the dynamic balancing recess sets being different from a depth of one of the balancing recesses of another one of the dynamic balancing recess sets; and
a paper-cutting blade mounted on the blade mount of the roller.

2. The rotary cutting module as claimed in claim 1, wherein the balancing recesses of the dynamic balancing recess sets are hexagonal recesses.

3. The rotary cutting module as claimed in claim 1, wherein the balancing recesses of the dynamic balancing recess sets are orderly arranged on the outer circumferential surface of the roller.

4. The rotary cutting module as claimed in claim 1, wherein the dynamic balancing recess sets include multiple first dynamic balancing recess sets and multiple second dynamic balancing recess sets;
the first dynamic balancing recess sets and the second dynamic balancing recess sets are arranged in a staggered manner along the rotating axis; and
the balancing recesses of each one of the first dynamic balancing recess sets and the adjacent balancing recesses of any one of the second dynamic balancing recess sets are arranged in a staggered manner along a circumference of the roller.

5. The rotary cutting module as claimed in claim 1, wherein a bottom of each one of the balancing recesses is a curved surface protruding outward.

6. A roller for a paper cutting device, being for constituting a rotary cutting module with a paper-cutting blade; the roller extending along a rotating axis and having:
a blade mount for mounting the paper-cutting blade formed on an outer circumferential surface of the roller; and
multiple dynamic balancing recess sets formed on the outer circumferential surface of the roller; the dynamic balancing recess sets disposed apart from each other along the rotating axis; each one of the dynamic balancing recess sets having
multiple balancing recesses annularly disposed apart from each other; a depth of one of the balancing recesses of one of the dynamic balancing recess sets being different from a depth of one of the balancing recesses of another one of the dynamic balancing recess sets.

7. The roller for a paper cutting device as claimed in claim 6, wherein the balancing recesses of the dynamic balancing recess sets are hexagonal recesses.

8. The roller for a paper cutting device as claimed in claim 6, wherein the balancing recesses of the dynamic balancing recess sets are orderly arranged on the outer circumferential surface of the roller.

9. The roller for a paper cutting device as claimed in claim 6, wherein the dynamic balancing recess sets include multiple first dynamic balancing recess sets and multiple second dynamic balancing recess sets;
the first dynamic balancing recess sets and the second dynamic balancing recess sets are arranged in a staggered manner along the rotating axis; and
the balancing recesses of each one of the first dynamic balancing recess sets and the adjacent balancing recesses of any one of the second dynamic balancing recess sets are arranged in a staggered manner along a circumference of the roller.

10. The roller for a paper cutting device as claimed in claim 6, wherein a bottom of each one of the balancing recesses is a curved surface protruding outward.
